(19) United States
(12) Patent Application Publication
(10) Pub. No.: US 2016/0357891 A1
(43) Pub. Date: Dec. 8, 2016

(54) SIMULATION METHOD, COMPUTER-READABLE RECORDING MEDIUM, AND SIMULATION APPARATUS

(71) Applicant: FUJITSU LIMITED, Kawasaki-shi (JP)

(72) Inventor: Hideyuki JIPPO, Atsugi (JP)

(73) Assignee: FUJITSU LIMITED, Kawasaki-shi (JP)

(21) Appl. No.: 15/238,951

(22) Filed: Aug. 17, 2016

Related U.S. Application Data
(63) Continuation of application No. PCT/JP2014/055330, filed on Mar. 3, 2014.

(51) Int. Cl. G06F 17/50; C01B 33/12; C01B 31/04

(52) U.S. Cl. CPC G06F 17/5009; C01B 31/0438; C01B 33/126; B82Y 35/00

(57) ABSTRACT

A simulation method is disclosed. A target structure is divided by a pattern of a unit structure for a stabilization calculation of an atomic arrangement. The stabilization calculation is conducted to calculate arrangement positions of atoms where a force between the atoms becomes stable, with respect to a structure in which one or more portions corresponding to the pattern of the unit structure are removed from the target structure. An added structure is created by adding one or more unit structures to the structure being stabilized by the stabilization calculation. The arrangement positions of the atoms in the target structure are stabilized by repeating the stabilization calculation with respect to the added structure.

### CROSS-REFERENCE TO RELATED APPLICATIONS

This application is a continuation application of International application PCT/JP2014/055330 filed on Mar. 3, 2014, the entire contents of which are incorporated herein by reference.

### FIELD

The present invention is related to a simulation method, a computer-readable recording medium, and a simulation apparatus.

### BACKGROUND

Recently, a crystal structure has been analyzed by a simulation using a computer. As a simulation technology, a technology is known to accurately predict a density distribution and size distribution of a void defect composed of a void in a single crystal and an inner-wall oxide film by a pulling up method.

### PATENT DOCUMENTS

Japanese Laid-open Patent Publication No. 2004-356253

### SUMMARY

According to one aspect of the embodiment, there is provided a simulation method, including dividing a target structure by a pattern of a unit structure for a stabilization calculation of an atomic arrangement; conducting the stabilization calculation to calculate arrangement positions of atoms where a force between the atoms becomes stable, with respect to a structure in which one or more portions corresponding to the pattern of the unit structure are removed from the target structure; creating an added structure by adding one or more unit structures to the structure being stabilized by the stabilization calculation; and stabilizing the arrangement positions of the atoms in the target structure by repeating the stabilization calculation with respect to the added structure.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a structure example having edges;

FIG. 2 is a diagram illustrating a structure example having an impurity;

FIG. 3A and FIG. 3B are diagrams for explaining general examples of an atomic structure stabilization process;

FIG. 4 is a diagram for explaining an atomic structure stabilization method according to an embodiment;

FIG. 5 is a diagram for explaining the atomic structure stabilization method according to the embodiment;

FIG. 6 is a diagram illustrating a hardware configuration of an atomic structure stabilization apparatus;

FIG. 7 is a diagram illustrating a functional configuration example of the atomic structure stabilization apparatus;

FIG. 8 is a flowchart for explaining processes from a procedure (A3) to a procedure (A7);

FIG. 9 is a diagram illustrating an example of a structure having edges;

FIG. 10 is a diagram illustrating an example of the atomic structure stabilization process with respect to a silicon oxide film;

FIG. 11 is a graph for explaining a comparison between the embodiment and a related art with respect to the structure in FIG. 9;

FIG. 12 is a diagram illustrating an example of an approximately periodic structure in which only one portion is irregular;

FIG. 13 is a diagram illustrating the atomic structure stabilization process with respect to a graphene sheet;

FIG. 14 is a diagram illustrating the atomic structure stabilization process with respect to the graphene sheet;

FIG. 15 is a diagram illustrating the atomic structure stabilization process with respect to the graphene sheet; and

FIG. 16 is a diagram illustrating the atomic structure stabilization process with respect to the graphene sheet.

### DESCRIPTION OF EMBODIMENTS

First, a simulation of a nanoscale structure by a computer will be broadly explained.

In the simulation of the nanoscale structure, there is mostly a case desired to acquire a stable atomic arrangement for a structure having irregularity at a portion alone in an approximately periodic structure. As the case desired to acquire the stable atomic arrangement, there may be a case in which the approximately periodic structure has an edge, a case in which impurities are included, and the like.

Acquiring the stable atomic arrangement corresponds to calculating a force acting on an atom, and repeating a process for moving the atom in accordance with the force until the force acting on each of all atoms becomes smaller than a conversion determination value. The acquiring of the stable atomic arrangement is called a “stabilization calculation”, and a structure in which the stable atomic arrangement is acquired is called a “stabilized structure”.

In a related art case, a calculation is conducted for the entire structure at one time for a structure desired to stabilize. In this method, the stabilization calculation is converged without a problem for a small scale structure. However, there is a problem in which the stabilization calculation does not converge for a large scale structure such as 1000 or more atoms.

In the following, an embodiment of the present invention will be described with reference to the accompanying drawings. In the embodiment, a technology will be provided to converge the stabilization calculation of the atomic arrangement at high speed.

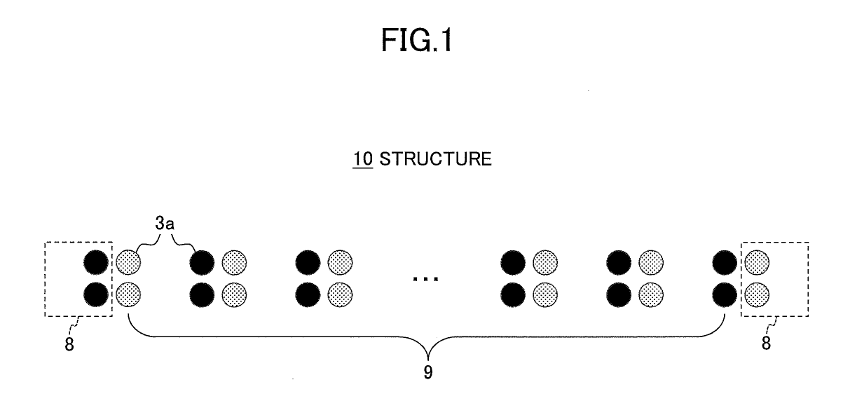

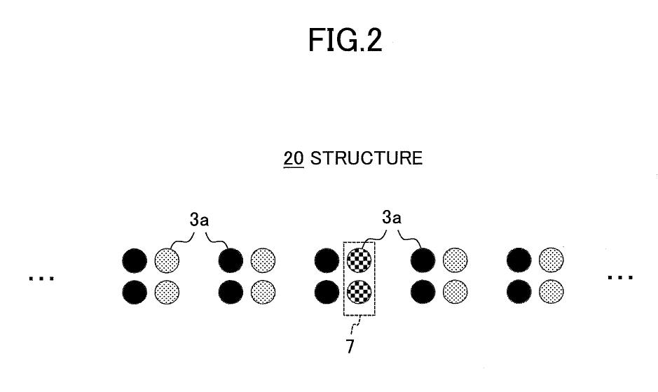

In the simulation of the nanoscale structure, there are many cases calculating a stable atomic arrangement for a structure having irregularity at a portion alone in the approximately periodic structure. A target structure example will be described with reference to FIG. 1 and FIG. 2. In FIG. 1 and FIG. 2, a circle shape represents one atom 3a, and different patterns filling in the circles represent different types of the atoms 3a.

FIG. 1 is a diagram illustrating a structure example having edges. In FIG. 1, a structure 10 having edges 8 is illustrated as an example of a structure periodically formed and including one irregular portion. A structure portion 9 in the structure 10 correspond to the approximately periodic structure.

FIG. 2 is a diagram illustrating a structure example having an impurity. In FIG. 2, a structure 20 having an impurity 7 is illustrated as an example of the approximately periodic structure having the irregular portion.

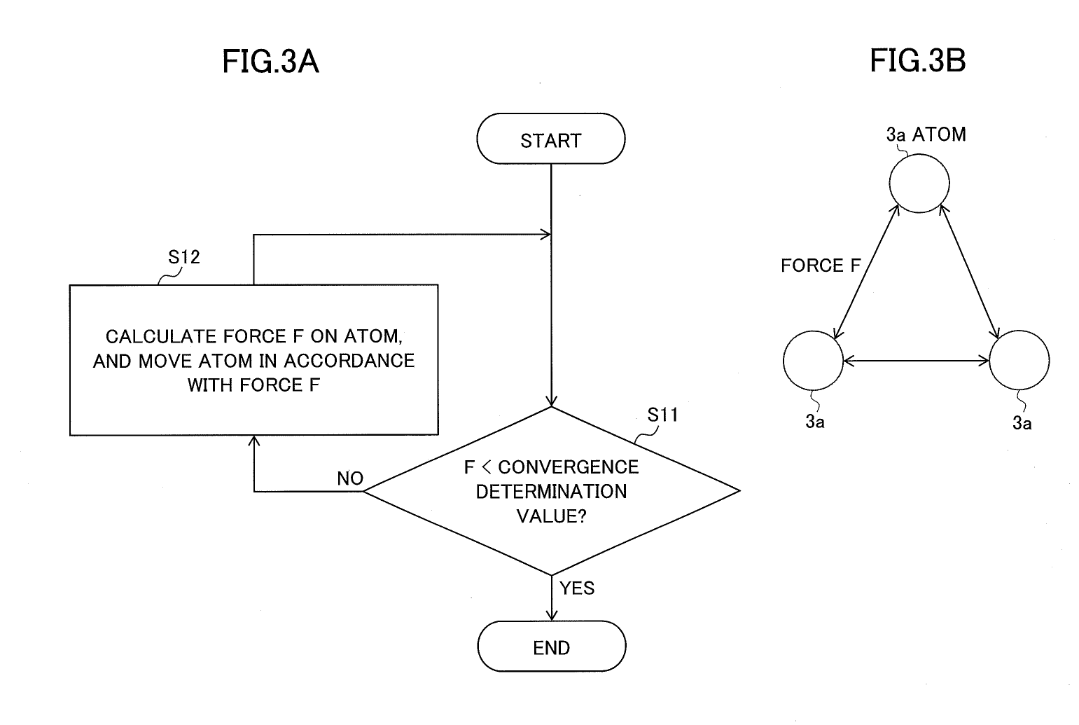

An atomic structure stabilization process simulates a position for each of the atoms 3a where a force F between the atoms 3a causes convergence. FIG. 3A and FIG. 3B are diagrams for explaining general examples of the atomic structure stabilization process. In the atomic structure stabilization process depicted in FIG. 3A, the force F (FIG. 3B) between the atoms 3a is less than a predetermined convergence determination value (step S11).

In a case in which the force F between the atoms 3a is greater than or equal to the convergence determination value, it is determined in the atomic structure stabilization process that an atomic structure has not been stabilized, the force F acting on the atoms 3a is calculated, and the atoms 3a are moved in accordance with the force F (step S12). After that, a determination process in the step S11 is conducted again.

By repeating processes in steps S11 and S12, when the force F between the atoms 3a becomes less than the convergence determination value, it is determined that the atomic structure has become stable. Then, the atomic structure stabilization process is terminated.

In the above described examples of the atomic structure stabilization process, that is, a force F acting on each of the atoms 3a is calculated, and the atoms 3a are moved in accordance with the forces F until the forces F on all the respective atoms 3a becomes less than the convergence determination value. For the small scale structure, the stabilization calculation is converged without a problem. However, the stabilization calculation becomes difficult to be converged for the large scale structure having 1000 or more atoms 3a.

In the following, the atomic structure stabilization method according to the embodiment will be described in which convergence of the stabilization calculation in the large scale structure is improved and calculation time is shortened. In the embodiment, the structure 10 being approximately periodic as depicted in FIG. 1 but including the irregular portion is assumed. In the following, the structure 10 having the edges 8 as depicted in FIG. 1 is explained as a structure example. However, the embodiment may be applied to the structure 20 including the impurity 7 as depicted in FIG. 2.

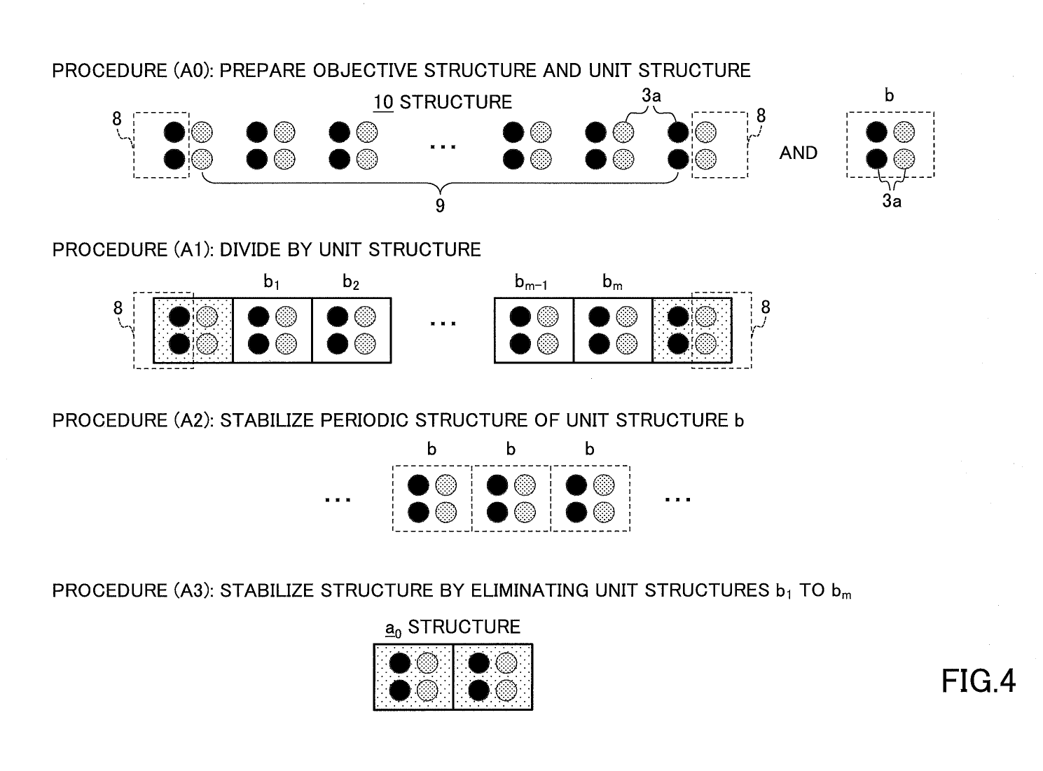

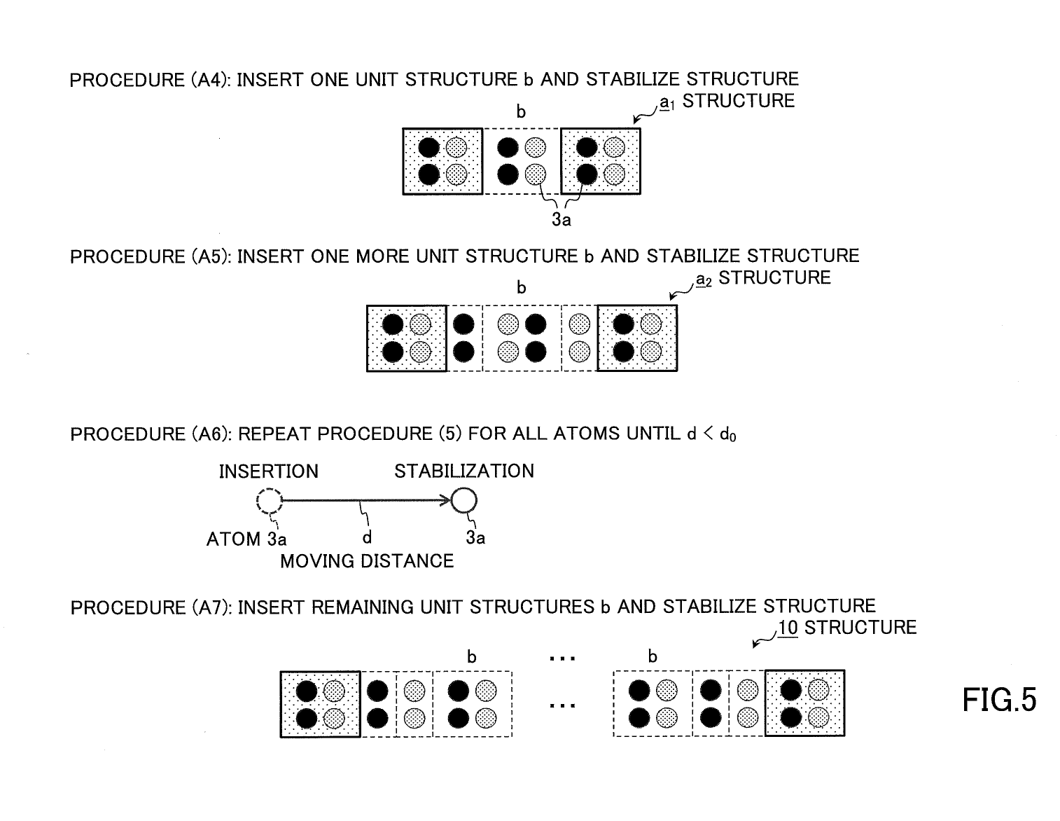

FIG. 4 and FIG. 5 are diagrams for explaining the atomic structure stabilization method according to the embodiment. In FIG. 4 and FIG. 5, referring to the structure 10 in FIG. 1 as the example, the atomic structure stabilization method according to the embodiment will be described from a procedure (A0) to a procedure (A7).

In the procedure (A0), the structure 10 and a unit structure b are prepared as subjects of the simulation.

In a procedure (A1), the structure 10 is divided by the unit structure b. By dividing the structure 10 by the unit structure b, m divisions of structures b₁ to bₘ are acquired. Each of the structures b₁ to bₘ is similar to the unit structure b. The unit structure b may correspond to the atomic structure having four atoms 3a.

In a procedure (A2), the periodic structure of the unit structure b is stabilized. The structures b₁ to bₘ are represented by m stabilized unit structures b.

In a procedure (A3), a structure a₀ is acquired by eliminating the structures b₁ to bₘ from the structure 10, and is stabilized. The structure ao includes the edges 8.

Referring to FIG. 5, in a procedure (A4), a structure a₁ is acquired by inserting the unit structure b into the stabilized structure a₀, and is stabilized.

In a procedure (A5), with respect to the structure a₁ stabilized in the procedure (A4), a structure a₂ is acquired by further inserting the unit structure b into the structure a₁, and is stabilized. The unit structure b is inserted so as to maintain periodicity. FIG. 5 exemplifies that the unit structure b is inserted in a middle of multiple unit structures b. However, this example is not limited to an insertion method.

If the periodicity is maintained for the inserted unit structures b, the unit structure b may be inserted into a center of the unit structure b based on the periodicity of the unit structures b. Alternatively, the unit structure b may be inserted between the structure a₀ and the unit structure b.

In a procedure (A6), the procedure (A5) is repeated until a moving distance d becomes a moving distance threshold d₀ for each of the atoms 3a. That is, a process for stabilizing the structure aₙ, in which the unit structure b is added to the stabilized structure aₙ₋₁ in a previous step, is repeated. Alternatively, a group formed by the unit structures b may be added. The moving distance threshold d₀ used for a determination may be approximately 20% of a distance between the atoms 3a.

In the procedure (A7), the structure 10 to be stabilized is created by adding remaining unit structures b, or a group formed by the unit structures b, and the stabilization calculation (simulation) is conducted.

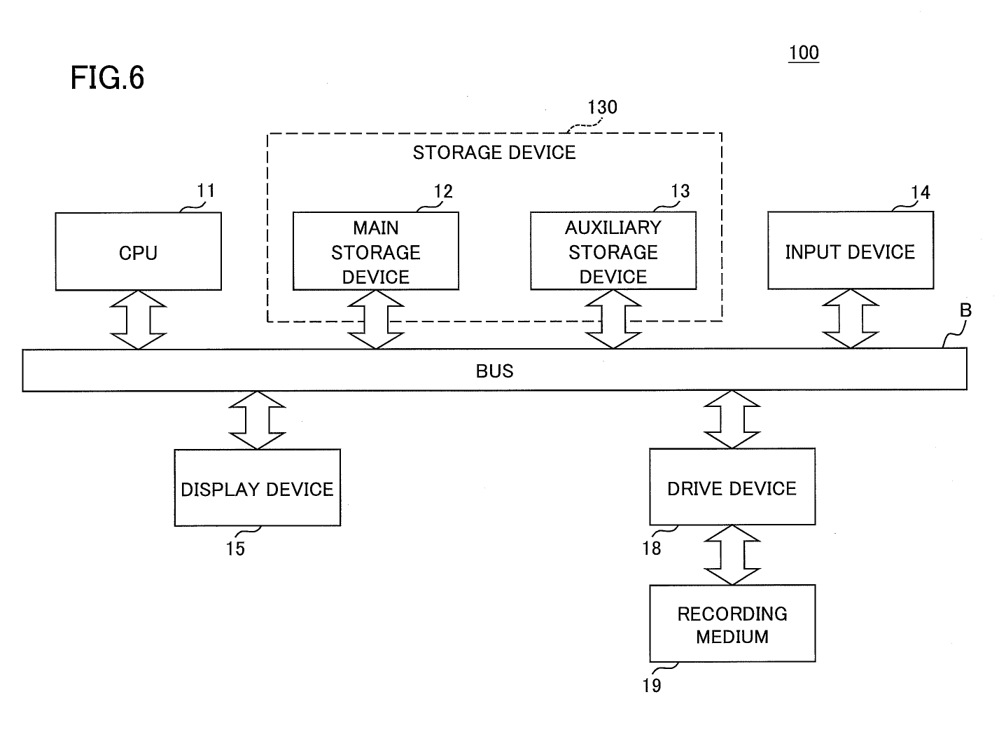

The atomic structure stabilization method according to the embodiment is conducted by an atomic structure stabilization apparatus including a hardware configuration as depicted in FIG. 6. FIG. 6 is a diagram illustrating the hardware configuration of the atomic structure stabilization apparatus. In FIG. 6, the atomic structure stabilization apparatus 100 is regarded as a simulation apparatus controlled by a computer, and includes a processor as a Central Processing Unit (CPU) 11, a main storage device 12, an auxiliary storage device 13, an input device 14, a display device 15, and a drive device 18, which are mutually connected via a bus B.

The CPU 11 controls the atomic structure stabilization apparatus 100 in accordance with a program stored in the main storage device 12. A Random Access Memory (RAM), a Read Only Memory (ROM), and the like are used as the main storage device 12. The main storage device 12 stores or temporarily retains data used in a process by the CPU 11, data acquired in the process by the CPU 11, and the like.

A Hard Disk Drive (HDD) or the like is used as the auxiliary storage device 13, and stores data including programs to perform various processes and the like. By loading a part of the program stored in the auxiliary storage device 13 into the main storage device 12, and executing the part of the program by the CPU 11, various processes are realized. The storage device 130 may correspond to at least one of the main storage device 12 and the auxiliary storage device 13.

The input device 14 includes a mouse, a keyboard, and the like, and is used by a user to input various information items used in a process in the atomic structure stabilization apparatus 100. The display device 15 displays various information items under control of the CPU 11.

The program for realizing the process conducted by the atomic structure stabilization apparatus 100 may be provided with a recording medium 19 such as a Compact Disc Read-Only Memory (CD-ROM) or the like to the atomic structure stabilization apparatus 100.

The drive device 18 interfaces between the recording medium 19 (which may be the CD-ROM or the like) being set to the drive device 18 and the atomic structure stabilization apparatus 100.

Also, the program for realizing the various processes according to the embodiment, which will be described later, is stored in the recording medium 19. The program stored in the recording medium 19 is installed into the atomic structure stabilization apparatus 100 through the drive device 18. The program upon being installed becomes executable for the atomic structure stabilization apparatus 100 to execute.

The recording medium 19 storing the programs is not limited to the CD-ROM, and may be a computer-readable, non-transitory, and tangible medium. As the computer-readable recording medium, the recording medium 19 may be a Digital Versatile Disk (DVD), a Universal Serial Bus (USB) memory, and a semiconductor memory such as a flash memory may be used, instead of the CD-ROM.

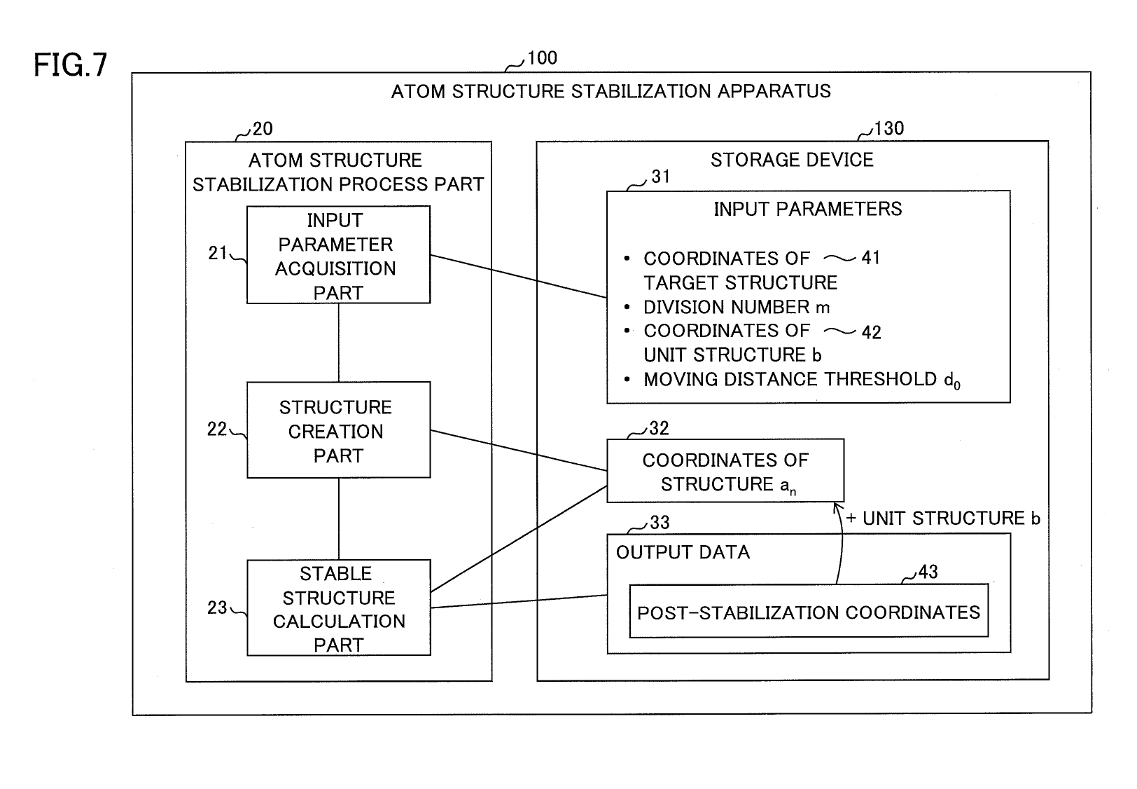

FIG. 7 is a diagram illustrating a functional configuration example of the atomic structure stabilization apparatus. In FIG. 7, the atomic structure stabilization apparatus 100 includes an atomic structure stabilization process part 20 according to the embodiment. The atomic structure stabilization process part 20 further includes, as process parts, an input parameter acquisition part 21, a structure creation part 22, and a stable structure calculation part 23. By processes conducted by the CPU 11 executing corresponding programs, the input parameter acquisition part 21, the structure creation part 22, and the stable structure calculation part 23 are realized.

Also, the storage device 130 stores input parameters 31, coordinates 32 of the calculation structure aₙ, output data 33, and the like.

The input parameter acquisition part 21 acquires the input parameters 31 from the storage device 130. The input parameter 31 includes coordinates 41 of a target structure of stabilization, a division number m, coordinates 42 of the unit structure b, and the moving distance threshold d₀, and the like.

Acquisition of the coordinates 41 of the target structure corresponds to the above described procedure (A0). In the procedure (A0), the coordinates 41 of the target structure having the irregular portion may be given by the user. As the coordinates 41 of the target structure having the irregular portion, the structure 10 (FIG. 1), the structure 20 (FIG. 2), or the like may be input. The coordinates 41 of the target structure include coordinates of all atoms 3a forming the target structure.

Also, the above described procedure (A1) is conducted by the user. The division number m acquired by dividing the target structure by a pattern of the unit structure b is given by the user, and is recorded with the input parameters 31 in the storage device 130.

The above described procedure (A2) is conducted beforehand in response to an instruction of the user. A periodic structure of the unit structure b is stabilized. The procedure (A2) may be conducted by using an existing technology. That is, with respect to the unit structure b, the atomic structure stabilization process is performed as described with reference to FIG. 3. A process in the procedure (A2) may be conducted at an apparatus different from the atomic structure stabilization apparatus 100 according to the embodiment. The coordinates 42 of the unit structure b being stabilized as a result of the process of the procedure (A2) are given as one of the input parameter 31.

Also, the moving distance threshold d₀, which is used to determine an end of an iterative stabilization calculation to stabilize the target structure, is also given by the user, and is stored as one input parameter 31 in the storage device 130.

Hence, the input parameters 31 in the storage device 130 include the coordinates 41 of the atomic structure, the division number m, and the coordinates 42 of the unit structure b being stabilized.

The structure creation part 22 creates, from an initial structure a₀, a structure in which one or more unit structures b are inserted for the stabilization calculation conducted by the stable structure calculation part 23. The initial structure a₀ is regarded as a structure in which m unit structures b are removed from the coordinates 41 of the structure having the irregular portion. The structure creation part 22 inserts the unit structure b so as to retain the periodicity.

The structure a₀ is created as an initial structure by eliminating a portion corresponding to m unit structures b from the coordinates 41 of the structure having the irregular portion. After that, for every stabilization calculation by the stable structure calculation part 23, the structure creation part 22 creates a next structure aₙ (1≦n≦m) subject to the stabilization calculation by adding the unit structure b with respect to post-stabilization coordinates 43 by the stable structure calculation part 23. The coordinates 32 of the next structure aₙ are stored in the storage device 130.

The stable structure calculation part 23 stabilizes the structure a₀ by executing a molecular dynamics calculation program. The post-stabilization coordinates 43, which are acquired as a result of the stabilization, are output as the output data 33 to the storage device 130. The output data 33 include the post-stabilization coordinates 43.

A first-principle calculation code OpenMX (refer to http://www.openmx-square.org/) or the like may be used as the molecular dynamics calculation program. The first-principle calculation code conducts an electronic state calculation of atoms and molecules based on a density functional theory by using an atom base function being numerical.

In the above described procedure (A3), the stable structure calculation part 23 performs a simulation with respect to the initial structure a₀ created by the structure creation part 22, and the post-stabilization coordinates 43, where the structure a₀ is stabilized, are acquired. The post-stabilization coordinates 43 are stored in the storage device 130.

In the above described procedure (A4), the structure creation part 22 creates the structure a₁ to which the unit structure b is inserted, with respect to the post-stabilization coordinates 43 acquired by stabilizing the structure a₀. The coordinates 32 of the structure a₁ are stored in the storage part 130. The stable structure calculation part 23 acquires the post-stabilization coordinates 43 of the structure a₁ where the structure a₁ is stabilized, based on the coordinates 32 of the structure a₁.

In the above described procedure (A5), the structure creation part 22 creates the structure a₂ where one unit structure b is inserted. The coordinates 32 of the structure a₂ are stored in the storage device 130. After that, the stable structure calculation part 23 acquires the post-stabilization coordinates 43 of the structure a₂ being stabilized, by conducting the simulation with respect to the structure a₂. The post-stabilization coordinates 43 of the structure a₂ are stored in the storage device 130.

In the above described procedure (A6), for each of the stabilization calculations by the stable structure calculation part 23, the post-stabilization coordinates 43 output from the stable structure calculation part 23 are compared with the coordinates 32 of the structure aₙ created by the structure creation part 22 before the stabilization. The structure aₙ is created by adding the unit structure b to a stabilized structure aₙ₋₁ until the moving distance d for each of the atoms 3a becomes shorter than the moving distance threshold d₀ given by the input parameters 31, and the structure aₙ is stabilized. Stabilizing of the structure aₙ is repeated. A maximum value of n is the division number m.

In the above described procedure (A7), when d<d₀ is satisfied, with respect to the structure aₙ being stabilized, the structure creation part 22 creates the structure aₙ₊₁ by adding (m-n) unit structures b together, and creates the coordinates 32 of the entire target structure to be stabilized. After that, the stable structure calculation part 23 stabilizes the structure aₙ₊₁, and the post-stabilization coordinates 43 are acquired as a final output in which the entire target structure is stabilized.

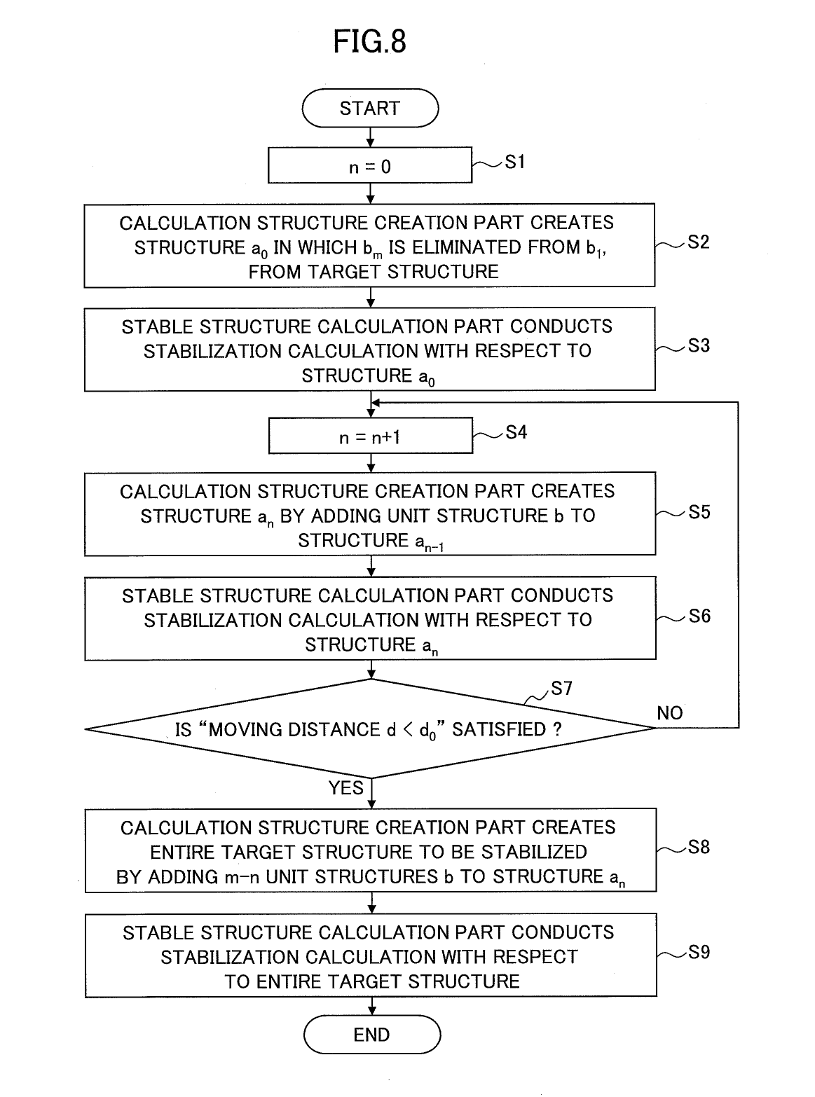

Processes from the procedure (A3) to the procedure (A7) are described with reference to FIG. 8. FIG. 8 is a flowchart for explaining the processes from the procedure (A3) to the procedure (A7). In FIG. 8, steps S1 to S3, steps S4 to S7, and steps S8 to S9 correspond to the procedure (A3), the procedures (A4) to (A6), and the procedure (A7), respectively.

Step S2, step S5, and step S8 are conducted by the structure creation part 22. Step S3, step S6, and step S9 are conducted by the stable structure calculation part 23.

In step S1, the atomic structure stabilization process part 20 initializes a variable n for counting a division number. In step S2, the structure creation part 22 creates the structure a₀ in which the structures b₁ to bₘ are removed from the target structure. In step S3, the stable structure calculation part 23 conducts the stabilization calculation with respect to the structure a₀.

In step S4, the atomic structure stabilization process part 20 increments the variable n by one. In step S5, the structure creation part 22 creates the structure aₙ by adding the unit structure b to the structure aₙ₋₁. In step S6, the stable structure calculation part 23 conducts the stabilization calculation with respect to the structure aₙ.

In step S7, the atomic structure stabilization process part 20 determines whether the moving distances d of all atoms 3a are shorter than the moving distance threshold d₀. When the moving distances d of any atoms 3a are longer than the moving distance threshold d₀ (NO in step S7), the atomic structure stabilization process part 20 goes back to step S4, and increments the variable n by one, and repeats the above described processes.

On the other hand, when the moving distances d of all atoms 3a are shorter than the moving distance threshold d₀ (YES in step S7), in step S8, the structure creation part 22 adds (m-n) unit structures b to the structure aₙ, and creates the entire target structure to be stabilized. The coordinates 32 of the entire target structure being created are stored in the storage device 130.

Further, in step S9, the stable structure calculation part 23 conducts the stabilization calculation with respect to the entire target structure. The stable structure calculation part 23 conducts the stabilization calculation by using the coordinates 32 of the entire target structure in the storage device 130, the post-stabilization coordinates 43 of the entire target structure are stored in the storage device 130. After that, the atomic structure stabilization process is terminated.

Next, by using an example of the structure which is approximately periodic and includes the irregular portion, the atomic structure stabilization process according to the embodiment will be described. First, a case of the structure having the edges will be described.

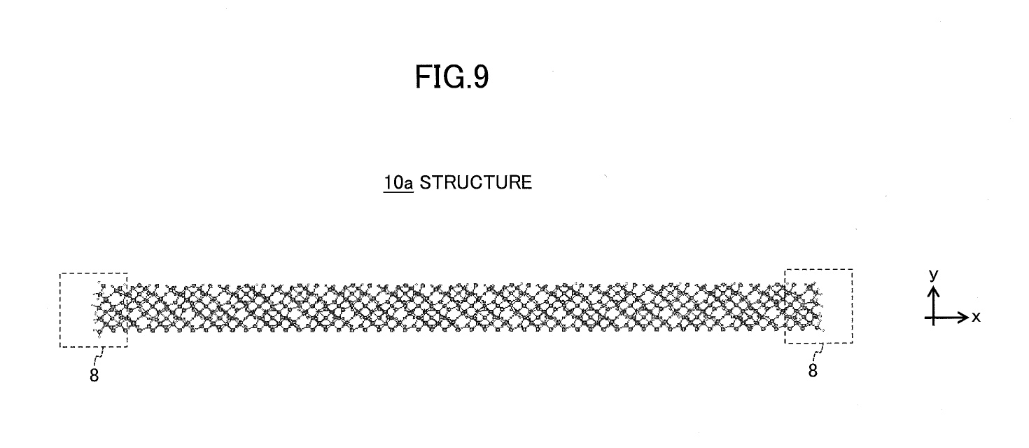

FIG. 9 is a diagram illustrating the example of the structure having the edges. In FIG. 9, a structure 10a is depicted as an atomic structure of a silicon substrate which has the edges 8 and of which surfaces are oxidized. In FIG. 9, the structure 10a is formed by silicon atoms, oxygen atoms, and hydrogen atoms. A silicon oxide film depicted as the structure 10a includes 1160 atoms.

A case, in which the atomic structure stabilization process according to the embodiment is conducted with respect to the structure 10a, will be described.

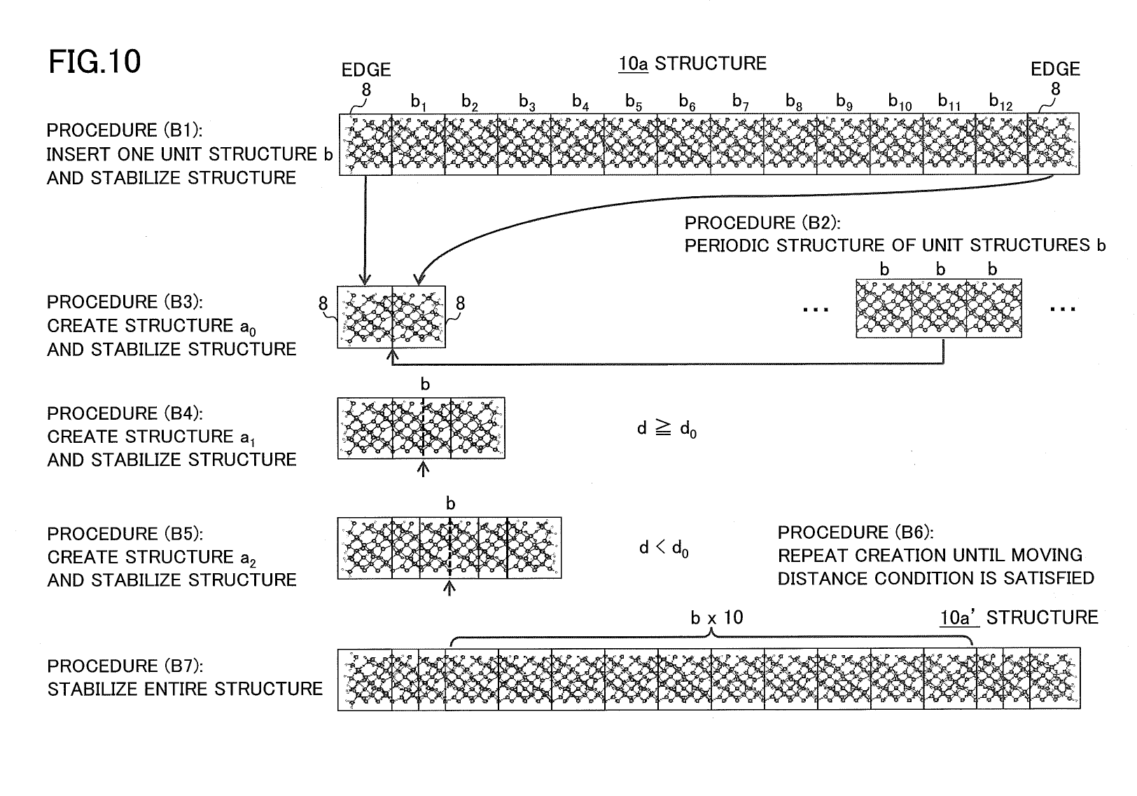

FIG. 10 is a diagram illustrating an example of the atomic structure stabilization process with respect to the silicon oxide film. A process is as follows, in a case in which the structure 10a (silicon oxide film) depicted in FIG. 9 is represented as the target structure. By inputting the structure 10a (the silicon oxide film) depicted in FIG. 9 as the target structure to the atomic structure stabilization apparatus 100, a procedure (B0) is terminated. The coordinates 41 of the target structure are stored in the storage part 130.

In a procedure (B1), the user removes the edges 8 from the structure 10a. The structure 10a is divided by the unit structure b defined beforehand by the user. The unit structure b is selected so that the periodicity when the structure a₀ is created in a procedure (B3) is consistent with that when the structure a₁ is created in a procedure (B4) described below.

In this example, the structure 10a, in which the edges 8 are removed, is divided into 12 portions. Accordingly, the division number m=12 is input into the atomic structure stabilization apparatus 100. Instead, coordinates of the edges 8 may be input as the coordinates 41 of the target structure.

In a procedure (B2), the periodic structure of the unit structure b is stabilized. The unit structure b being stabilized is input into the atomic structure stabilization apparatus 100. Also, the moving distance threshold d₀ is input by the user. As the input parameters 31 in the storage device 130, the coordinates 41 of the structure 10a, the division number m=12, the coordinates 42 of the unit structure b, and the moving distance threshold d₀ are stored.

In the procedure (B3), the structure creation part 22 creates the structure a₀ of the edges 8 alone based on the coordinates 41. The coordinates 32 of the structure a₀ are stored in the storage device 130. The stable structure calculation part 23 conducts the stabilization calculation with respect to the coordinates 32 of the structure a₀. The post-stabilization coordinates 43 of the structure a₀ are stored in the storage part 130.

In the procedure (B4), the structure creation part 22 creates the structure a₁ by inserting the unit structure b into the stabilized structure a₀. The coordinates 32 of the structure a₁ are stored in the storage device 130. After that, the stable structure calculation part 23 conducts the stabilization calculation with respect to the coordinates 32 of the structure a₁. The post-stabilization coordinates 43 of the structure a₁ are stored in the storage device 130.

In a procedure (B5), the structure creation part 22 creates the structure a₂ by inserting the unit structure b into the stabilized structure a₁. The coordinates 32 of the structure a₂ are stored in the storage device 130. After that, the stable structure calculation part 23 conducts the stabilization calculation with respect to the coordinates 32 of the structure a₂. The post-stabilization coordinates 43 of the structure a₂ are stored in the storage device 130.

In a procedure (B6), depending on a determination result of whether the moving distance condition (d<d₀) is satisfied, the procedure (B5) or a procedure (B7) is performed. When the moving distance d is longer than or equal to the moving distance threshold d₀ (d≧d₀), the procedure (B5) is repeated. When the moving distance d becomes shorter than the moving distance threshold d₀ (d<d₀), the atomic structure stabilization process advances to the procedure (B7).

In the procedure (B7), the structure creation part 22 creates the structure 10a′ by adding 10 unit structures b at a time to the stabilized structure a₂, and creates the coordinates 32 of the entire target structure to be stabilized. The coordinates 32 of the structure 10a′ are stored in the storage device 130.

After that, the stable structure calculation part 23 acquires the post-stabilization coordinates 43 in which the entire target structure as the final output is stabilized, by stabilizing the structure 10a′. The post-stabilization coordinates 43, in which the entire target structure is stabilized, are included in the output data 33, and are stored in the storage device 130.

When the moving distance condition (d<d₀) is satisfied in the structure a₂, ten unit structures b are added to the structure a₂. The structure 10a′ is regarded as a structure acquired by adding 10 unit structures b to the structure a₂, and represents the structure 10a. Since each of the unit structures b is stabilized beforehand, it is possible to perform the stabilization calculation of the structure 10a′ at higher speed.

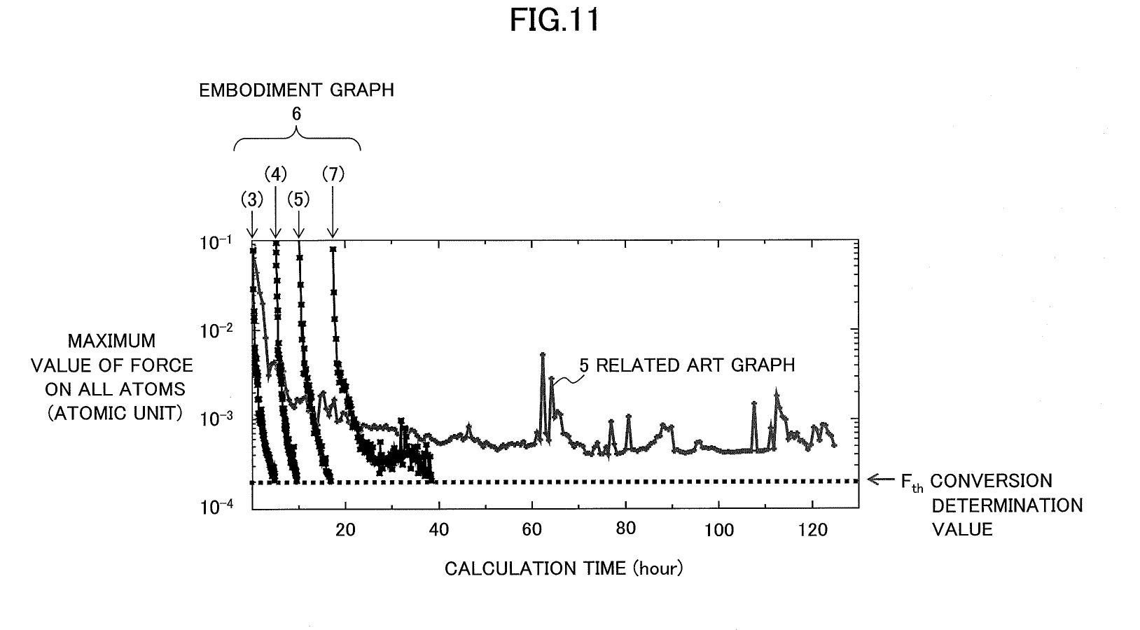

FIG. 11 is a graph for explaining a comparison between the embodiment and the related art with respect to the structure 10a in FIG. 9. In the graph depicted in FIG. 11, a vertical axis indicates a maximum value (an atomic unit) of a force F acting on all atoms, and a horizontal axis indicates a calculation time (hours).

The maximum value (the atomic unit) of the force F acting on the all atoms in the vertical axis is calculated by the molecular dynamics calculation program. The calculation time in the horizontal axis represents the hours spent until the structure is stabilized by the stabilization calculation.

A convergence determination value Fₜₕ illustrated in FIG. 11 is used to determine whether the structure is stabilized. When the maximum value of the force F acting on the all atoms becomes less than the convergence determination value, the stabilization is completed. In this case, as the convergence determination value, 2×10⁻⁴ may be used.

A related art graph 5 represents a transition of the maximum value of the force F acting on all atoms in a case of conducting the stabilization calculation for the entire target structure without dividing the target structure into the unit structures b. The atoms are moved in the entire target structure. Thus, a calculation for moving the atoms becomes complicated. In a case of the silicon oxide film (the structure 10a) having 1160 atoms, the force F does not become less than or equal to 4×10⁻⁴, and the conversion determination value Fₜₕ has not been achieved even if 120 hours are spent for the calculation.

An embodiment graph 6 represents a transition of the maximum value of the force F acting on all atoms for each of the procedure (B3), the procedure (B4), the procedure (B5), and the procedure (B7) which are described above.

In a case of the embodiment graph 6, the stabilization calculation with respect to the structure a₀ having the edges 8 alone in the procedure (B3) has achieved the convergence determination value Fₜₕ at approximately five hours on the axis of the calculation time. Also, the stabilization calculation with respect to the structure a₁, in which one unit structure b is added to the structure a₀ in the procedure (B4), has achieved the convergence determination value Fₜₕ at approximately ten hours on the axis of the calculation time.

Furthermore, the stabilization calculation with respect to the structure a₂, in which one unit structure b is added to the structure a₁ in the procedure (B5), has achieved the convergence determination value Fₜₕ at approximately 19 hours on the axis of the calculation time. Since the moving distance condition (d<d₀) is satisfied by the stabilization calculation in the procedure (B5), the stabilization calculation is conducted with respect to the structure 10a′ in which all 10 remaining unit structures b are added to the structure a₂. In this case, the convergence determination value Fₜₕ is achieved at approximately 40 hours on the axis of the calculation time, and the stabilization calculation is completed.

As described above, in the embodiment graph 6, the convergence of the stabilization calculation of the structure 10, which has not been realized in the related art graph 5, is improved, and a calculation speed is increased.

In a case of using the moving distance threshold d₀=0.6 Å, the moving distance condition of d<d₀ is satisfied at n=1 (corresponding to the structure a₁), and the stabilization calculation advances to the procedure (B7). However, similar to the related art 5, it is difficult to obtain a desired convergence. In a case of using d₀=0.1 Å, the d<d₀ condition is satisfied when n=6. Eight stages, that is, the stabilization of the structure a₀, the stabilization of the structure a₁, the stabilization of the structure a₂, . . . (omission) . . . , the stabilization of the structure a₆, and the stabilization of the structure 10 which is a target to be stabilized are conducted for the stabilization calculation. Even though the stabilization calculation is converged, a number of stages of the stabilization calculation is twice or more than the case of the moving distance threshold d₀=0.4 Å. Hence, it is important to set a proper moving distance threshold d₀ in order to increase the speed of the stabilization calculation.

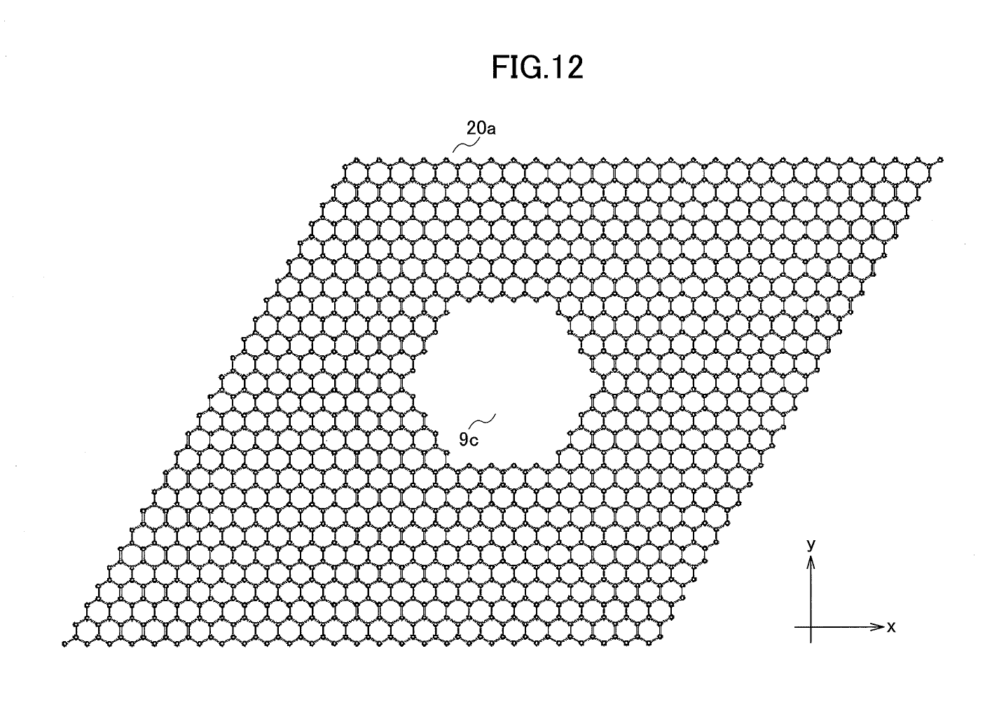

Next, the stabilization calculation will be described in a case in which one irregular portion exists in an approximately periodic structure. FIG. 12 is a diagram illustrating an example of the approximately periodic structure in which only one portion is irregular. In FIG. 12, a structure 20a corresponds to a unit cell in a structure example of a graphene sheet having a void 9c. The structure 20a depicted in FIG. 12 may be periodically arranged in a x-direction and a y-direction. The structure 20a corresponding to the unit cell is formed by 1256 carbon atoms.

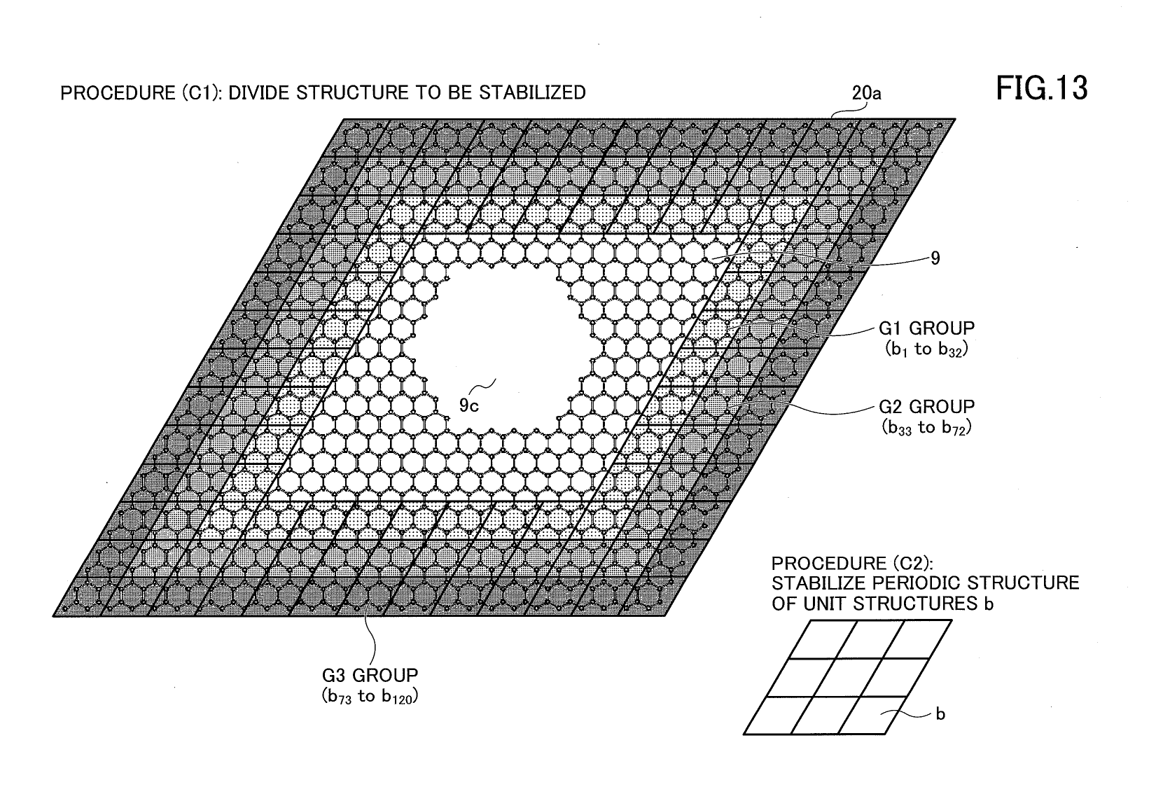

The atomic structure stabilization process with respect to the structure 20a in the embodiment will be described with reference to FIG. 13 to FIG. 16.

FIG. 13 to FIG. 16 are diagrams illustrating the atomic structure stabilization process with respect to the graphene sheet. The stabilization process will be described below for a case in which the structure 20a (the graphene sheet) illustrated in FIG. 12 is set as the target structure. The structure 20a (the graphene sheet) in FIG. 12 is input as the target structure to the atomic structure stabilization apparatus 100, and the procedure (C0) is terminated. The coordinates 41 of the target structure are stored in the storage device 130.

In a procedure (C1), the user divides the structure 20a into a region 9 of the void 9c in a center, a group G1 including unit structures b₁ to b₃₂ surrounding the region 9, a group G2 including unit structures b₃₃ to b₇₂, and a group G3 including unit structures b₇₃ to b₁₂₀.

The unit structures b₁ to b₁₂₀ are collectively called “unit structures b”. The unit structure b is selected so that the periodicity when the structure a₀ is created in a procedure (C3) is consistent with that when the structure a₁ is created in a procedure (C4) described blow.

In this example, the structure 20a other than the void 9c is divided into 120 divisions. The unit structures b are grouped in order to effectively conduct the stabilization calculation. The group G1 corresponds to a structure surrounding the region 9 having the void 9c by the unit structures b. Also, the group G2 corresponds to a structure surrounding a periphery of the group G1 by the unit structures b. Furthermore, the group G3 corresponds to a structure surrounding a periphery of the group G2 by the unit structures b.

In the procedure (C2), the periodic structure formed by the unit structures b is stabilized. The unit structures b being stabilized are input to the atomic structure stabilization apparatus 100. Moreover, the moving distance threshold d₀ is input by the user. As the input parameters 31 in the storage device 130, the coordinates 41 of the structure 20a, the division number m=120, the coordinates 42 of the unit structures b, and the moving distance threshold d₀ are stored.

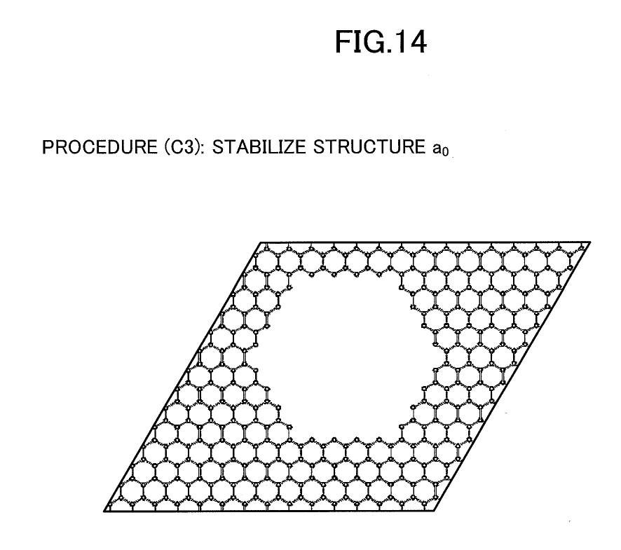

In the procedure (C3) (FIG. 14), the structure creation part 22 creates the structure a₀ of the region 9 alone based on the coordinates 41. The coordinates 32 of the structure a₀ are stored in the storage device 130. Also, the stable structure calculation part 23 conducts the stabilization calculation with respect to the coordinates 32 of the structure a₀. The post-stabilization coordinates 43 of the structure a₀ are stored in the storage device 130.

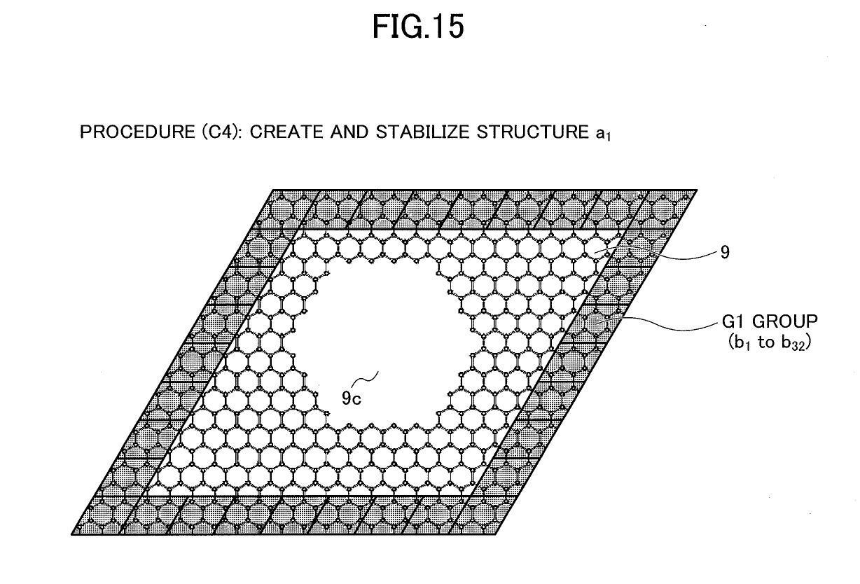

In the procedure (C4) (FIG. 15), the structure creation part 22 creates the structure a₁ in which 32 unit structures b corresponding to the group G1 are added to the periphery of the structure a₀ stabilized in the procedure (C3). The coordinates 32 of the structure a₁ are stored in the storage device 130. Furthermore, the stable structure calculation part 23 conducts the stabilization calculation with respect to the coordinates 32 of the structure a₁. The post-stabilization coordinates 43 of the structure a₁ are stored in the storage device 130.

In this example, the moving distances d of all atoms are less than or equal to the moving distance threshold d₀ at a stage of the structure a₁. Hence, the procedure (C4) is terminated. The moving distance threshold d₀=0.2 Å is used.

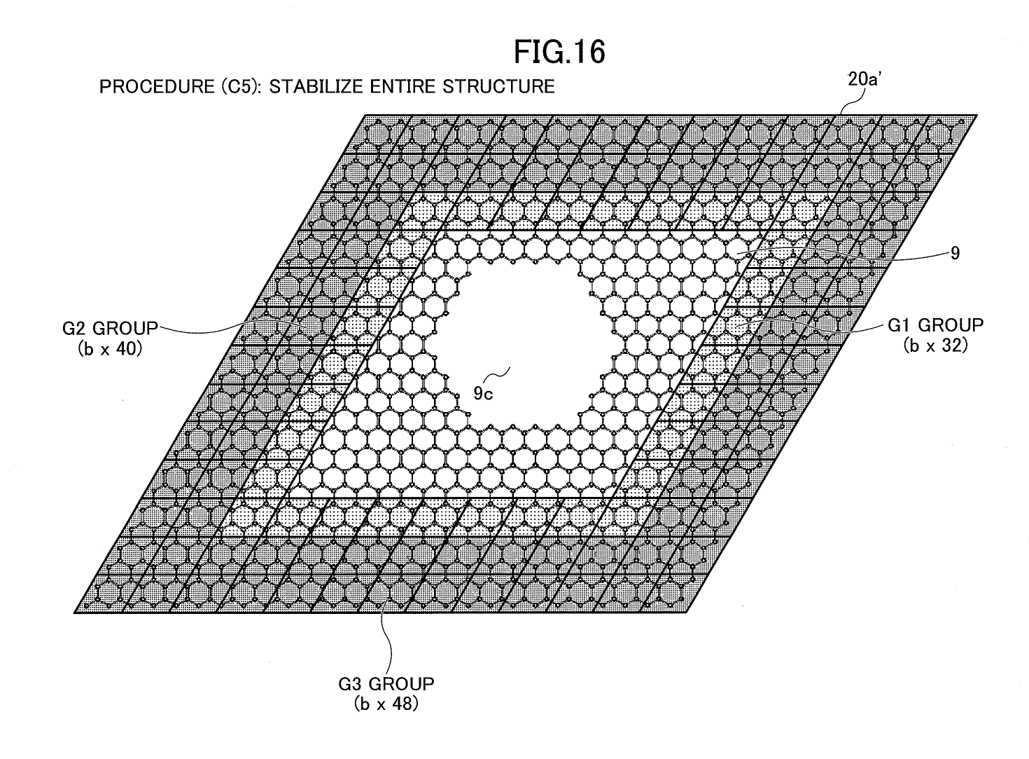

In the procedure (C5) (FIG. 16), the structure creation part 22 adds 40 unit structures b corresponding to the group G2 and 48 unit structures b corresponding to the group G3 to the periphery of the structure a₁, creates a structure 20a′ desired to be stabilized, and creates the coordinates 32 of the entire target structure to be stabilized. The coordinates 32 of the structure 20a′ are stored in the storage device 130.

After that, the stable structure calculation part 23 acquires the post-stabilization coordinates 43 in which the entire target structure being the final output is stabilized, by stabilizing the structure 20a′. The post-stabilization coordinates 43 in which the entire target structure is stabilized are included in the output data 33, the output data 33 are stored in the storage device 130.

By the above described procedures (C1) to (C5), it is possible to conduct the stabilization calculation with respect to the structure 20a having the void 9c for the graphene sheet at higher speed.

As described above, the convergence of the stabilization calculation is improved for the large scale structure, and the calculation time is shortened. Especially, in a case of the target structure having one irregular portion, an effect by the embodiment is greater.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A simulation method, comprising:
dividing a target structure by a pattern of a unit structure for a stabilization calculation of an atomic arrangement;
conducting the stabilization calculation to calculate arrangement positions of atoms where a force between the atoms becomes stable, with respect to a structure in which one or more portions corresponding to the pattern of the unit structure are removed from the target structure;
creating an added structure by adding one or more unit structures to the structure being stabilized by the stabilization calculation; and
stabilizing the arrangement positions of the atoms in the target structure by repeating the stabilization calculation with respect to the added structure.

2. The simulation method according to claim 1, further comprising:
terminating the repeating of the stabilization calculation, when a moving distance of the atoms become less than a moving distance threshold by the stabilization calculation with respect to the added structure;
creating the target structure by adding remaining unit structures based on a division number, to the added structure; and
conduct the stabilization calculation with respect to the target structure being created.

3. The simulation method according to claim 1, wherein the stabilization calculation uses a molecular dynamics calculation.

4. The simulation method according to claim 1, wherein the added structure is created by adding the unit structure so as to retain periodicity.

5. The simulation method according to claim 1, the target structure is approximately periodic and includes one irregular portion.

6. The simulation method according to claim 1, wherein the target structure is a silicon oxide film including an edge.

7. The simulation method according to claim 1, wherein the target structure is a unit cell of a graphene sheet having a void.

8. A non-transitory computer-readable recording medium that stores a simulation program that causes a computer to execute a process comprising:
dividing a target structure by a pattern of a unit structure for a stabilization calculation of an atomic arrangement;
conducting the stabilization calculation to calculate arrangement positions of atoms where a force between the atoms becomes stable, with respect to a structure in which one or more portions corresponding to the pattern of the unit structure are removed from the target structure;
creating an added structure by adding one or more unit structures to the structure being stabilized by the stabilization calculation; and
stabilizing the arrangement positions of the atoms in the target structure by repeating the stabilization calculation with respect to the added structure.

9. A simulation apparatus, comprising:
a processor that executes a process that includes:
dividing a target structure by a pattern of a unit structure for a stabilization calculation of an atomic arrangement;
conducting the stabilization calculation to calculate arrangement positions of atoms where a force between the atoms becomes stable, with respect to a structure in which one or more portions corresponding to the pattern of the unit structure are removed from the target structure;
creating an added structure by adding one or more unit structures to the structure being stabilized by the stabilization calculation; and
stabilizing the arrangement positions of the atoms in the target structure by repeating the stabilization calculation with respect to the added structure.
